(19) United States
(12) Patent Application Publication
(10) Pub. No.: US 2025/0095032 A1
(43) Pub. Date: Mar. 20, 2025

(54) Dynamic Vehicle Safety and Value Assessment Enabled by Real Time Network IoT Sensor Data Analysis

(71) Applicant: International Business Machines Corporation, Armonk, NY (US)

(72) Inventors: Neil Delima, Scarborough (CA); Su Liu, Austin, TX (US); Hamid Majdabadi, Ottawa (CA); Yang Liang, Beijing (CN)

(21) Appl. No.: 18/470,277

(22) Filed: Sep. 19, 2023

(51) Int. Cl. G06Q 30/02

(52) U.S. Cl. CPC G06Q 30/0278

(57) ABSTRACT

Dynamic vehicle assessment is provided. A baseline value of a vehicle is determined based on current market values of a set of vehicles similar to the vehicle with regard to similar year, make, model, and mileage. A percentage of deviation from the baseline value of the vehicle is determined based on a cost to repair a set of given parts of the vehicle predicted to fail within a defined time period. A real time actual market value of the vehicle is determined based on the percentage of deviation from the baseline value of the vehicle according to the cost to repair the set of given parts of the vehicle predicted to fail within the defined time period. The real time actual market value of the vehicle is sent to a requester via a network in response to receiving a request for an assessment of the vehicle.

### BACKGROUND

The disclosure relates generally to vehicles and more specifically to vehicle safety and value assessment.

Current supply chain shortages are having a significant impact on manufacturing of new vehicles and have boosted the demand for used vehicles. As a result, maintaining a vehicle in good working order is important for resale value. For example, by following a vehicle's maintenance schedule, problems or breakdowns can be prevented. In addition, by keeping the maintenance history of a vehicle, the vehicle's resale value can be enhanced.

Also, using aftermarket parts to replace malfunctioning or damaged parts on a vehicle can impact the value of that vehicle. For example, aftermarket parts are not always as safe and do not have the same warranties as original manufacturer parts. Further, how a user drives a vehicle and under what conditions can directly influence performance and longevity of the vehicle's parts, which also affects the safety and value of that vehicle.

### SUMMARY

According to one illustrative embodiment, a computer-implemented method for dynamic vehicle assessment is provided. A computer determines a baseline value of a vehicle based on current market values of a set of vehicles similar to the vehicle with regard to similar year, make, model, and mileage. The computer determines a percentage of deviation from the baseline value of the vehicle based on a cost to repair a set of given parts of the vehicle predicted to fail within a defined time period. The computer determines a real time actual market value of the vehicle based on the percentage of deviation from the baseline value of the vehicle according to the cost to repair the set of given parts of the vehicle predicted to fail within the defined time period. The computer sends the real time actual market value of the vehicle to a requester via a network in response to receiving a request for an assessment of the vehicle. According to other illustrative embodiments, a computer system and computer program product for dynamic vehicle assessment are provided.

### BRIEF DESCRIPTION OF THE DRAWINGS

FIG. 1 is a pictorial representation of a computing environment in which illustrative embodiments may be implemented;

FIG. 2 is a diagram illustrating an example of a vehicle safety and value assessment system in accordance with an illustrative embodiment;

FIG. 3 is a diagram illustrating an example of a vehicle Internet of Things (IoT) sensor system in accordance with an illustrative embodiment; and

FIGS. 4A-4B are a flowchart illustrating a process for dynamic vehicle safety and value assessment in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

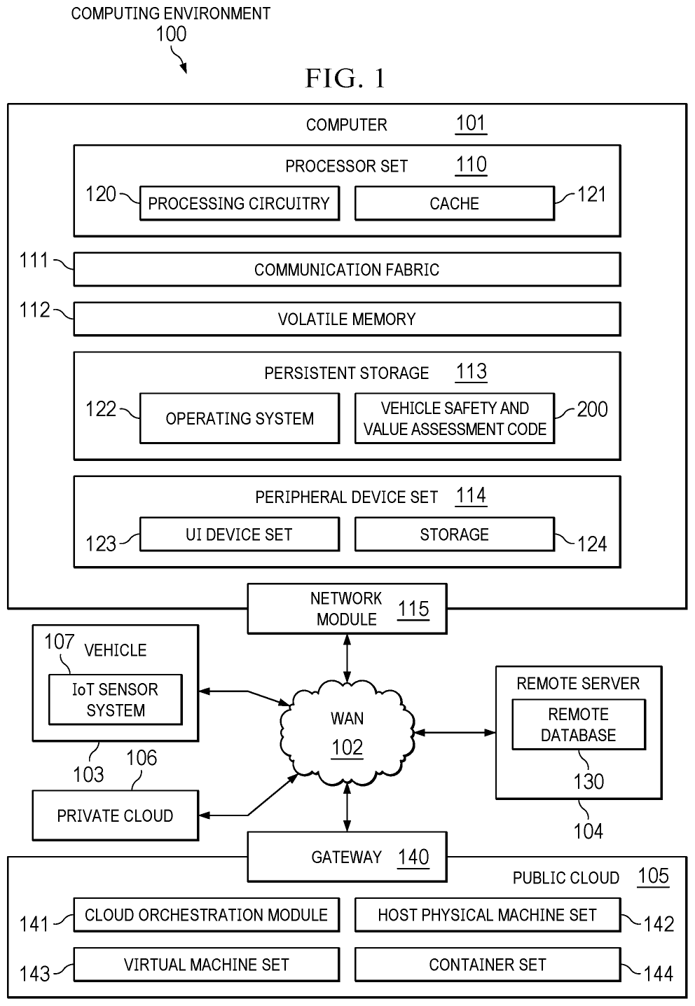

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as vehicle safety and value assessment code 200. For example, vehicle safety and value assessment code 200 performs network analysis of IoT sensor data received from a vehicle to dynamically estimate value of the vehicle by determining deviation of a determined real time value of the vehicle from an established baseline value based on a predicted likelihood of part failure in the vehicle within a defined time period and estimated repair cost of the failed part. Vehicle safety and value assessment code 200 dynamically estimates the deviation from the baseline value of the vehicle by monitoring vehicle part operational data, while considering vehicle maintenance schedules and authenticity of parts (e.g., original manufacturer parts), to predict part failure and cost of repair that impact the value of the vehicle. Thus, vehicle safety and value assessment code 200 provides greater transparency in vehicle condition, which is beneficial to both the potential buyer and seller regarding vehicle safety and resale value.

In addition to vehicle safety and value assessment code 200, computing environment 100 includes, for example, computer 101, wide area network (WAN) 102, vehicle 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and vehicle safety and value assessment code 200, as identified above), peripheral device set 114 (including user interface (UI) device set 123 and storage 124), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in vehicle safety and value assessment code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

Vehicle 103 can represent any type of vehicle (e.g., car, truck, van, bus, semi, motorcycle, or the like) that is used and controlled by a user (e.g., an owner who registered vehicle 103 for the vehicle safety and value assessment service provided by computer 101). Also, it should be noted that vehicle 103 can represent a multitude of vehicles registered for the vehicle safety and value assessment service provided by computer 101. Vehicle 103 includes a network module, which is similar to network module 115, that allows vehicle 103 to communicate with computer 101 via WAN 102. Vehicle 103 typically receives helpful and useful data from the operations of computer 101. For example, in a hypothetical case where computer 101 is designed to provide a safety notification regarding predicted vehicle part failure to the user, this safety notification would typically be communicated from network module 115 of computer 101 via WAN 102 to vehicle 103. In this way, vehicle 103 can display, or otherwise present, the predicted vehicle part failure safety notification to the user of vehicle 103 to increase user and vehicle safety.

Vehicle 103 includes IoT sensor system 107. IoT sensor system 107 is comprised of different sets of sensors (e.g., heat sensors, pressure sensors, speed sensors, acceleration sensors, voltage sensors, and the like) corresponding to different parts, components, or systems (e.g., engine, ignition, transmission, brakes, suspension, tires, and the like) of vehicle 103. Vehicle safety and value assessment code 200 collects data from IoT sensor system 107 and analyzes the data to predict whether any of the plurality of parts comprising vehicle 103 is likely to fail within a defined time period. It should be noted that vehicle safety and value assessment code 200 can include a set of machine learning models for generating vehicle part failure predictions.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a vehicle value assessment based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Currently, various tools and websites exist that allow potential vehicle sellers and buyers to estimate the value of a vehicle. These currently existing tools and websites mostly rely on information, such as, for example, vehicle year, make, and model, odometer reading, zip code, number of owners, images of the vehicle, and the like, to generate an estimated value of a vehicle based on averages of vehicles with similar parameters. However, these currently existing tools and websites make it difficult for potential buyers to detect whether any undisclosed issues exist, such as, for example, improper vehicle maintenance and servicing, use of inauthentic parts on a vehicle, aggressive driving history of a vehicle, and the like. As a result of utilizing these currently existing tools and websites to estimate vehicle value, buyers are not made aware of certain issues with a vehicle when purchasing that vehicle. These types of undisclosed issues with a vehicle can significantly impact the post purchase costs of maintenance, lifespan, and safety of the vehicle, as well as increase insurance premiums.

Illustrative embodiments take into account and address the shortcomings of these currently exiting tools and websites for vehicle value estimation by providing a dynamic and complete assessment of the safety and value of a vehicle. For example, illustrative embodiments obtain information regarding the age, origin, and condition of a vehicle's parts, which can impact the vehicle's performance and safety. Thus, illustrative embodiments can provide a seller with an accurate vehicle resale value assessment and a potential buyer with a safety assessment and fair purchase price.

Illustrative embodiments provide the dynamic vehicle safety and value assessment by determining in real time the deviation of the value of the vehicle in its current condition from an estimated market value of that vehicle as compared to vehicles of similar year, make, model, and mileage, with similar optional features. For example, illustrative embodiments build a first data warehouse containing vehicle attribute data, such as, for example, year, make, model, mileage, current estimated market value, and the like, for a plurality of different vehicles. In addition, illustrative embodiments build a second data warehouse containing vehicle part data, such as, for example, descriptions and stock keeping units of parts for the plurality of different vehicles according to vehicle year, make, and model, along with cost of the parts, average longevity of the parts, manufacturer of the parts, cost to repair the parts, and the like.

Moreover, illustrative embodiments generate and update a digital twin of each vehicle registered with the vehicle safety and value assessment services of illustrative embodiments. The digital twin contains vehicle attribute and part details, real time IoT sensor data corresponding to operation and performance of the different parts of the vehicle received from a plurality of IoT sensors onboard the vehicle, maintenance records corresponding to the vehicle received from a set of vehicle repair shop computers, and a listing of currently installed parts on the vehicle and their historic details (i.e., part provenance or the authenticity and traceability of the parts on the vehicle) obtained from a distributed ledger-based (e.g., blockchain) vehicle parts tracking system or service. The digital twin generator of illustrative embodiments also includes a set of machine learning models to predict likelihood of failure of respective parts based on the vehicle's details, real time IoT sensor data corresponding to the different parts of the vehicle received from the plurality of IoT sensors onboard the vehicle, maintenance records of the vehicle, and provenance of the vehicle's parts contained in the digital twin of the vehicle.

Illustrative embodiments estimate the cost of repair and maintenance based on the predicted likelihood of part failure within a defined period of time. Illustrative embodiments utilize the vehicle attribute data retrieved from the first vehicle data warehouse, the real time IoT sensor data corresponding to the different parts of the vehicle received from the plurality of IoT sensors onboard the vehicle, and the maintenance records of the vehicle from the vehicle repair shop computer to train the set of machine learning models to predict in real-time the likelihood of failure of vehicle parts and predict the timeframe when the part failure is likely to occur. In response to predicting the likelihood of vehicle part failure, illustrative embodiments estimate in real time the cost of replacing the failed vehicle part and future maintenance over a timeframe using the vehicle part data retrieved from the second vehicle data warehouse. Illustrative embodiments establish a baseline value of the vehicle based on the current estimated market value of similar vehicles. Illustrative embodiments determine the percentage of deviation from the baseline value of the vehicle in real-time based on the estimated cost for replacing the failed vehicle part and maintenance over the timeframe. Illustrative embodiments generate in real time an actual current value of the vehicle based on the determined percentage of deviation from the baseline value of the vehicle. Then, illustrative embodiments output the actual value of the vehicle, along with one of a buy recommendation or a sell recommendation.

Thus, illustrative embodiments provide one or more technical solutions that overcome a technical problem with an inability of current solutions to take into account predicted vehicle part failure when assessing vehicle safety and value. As a result, these one or more technical solutions provide a technical effect and practical application in the field of vehicle safety assessment.

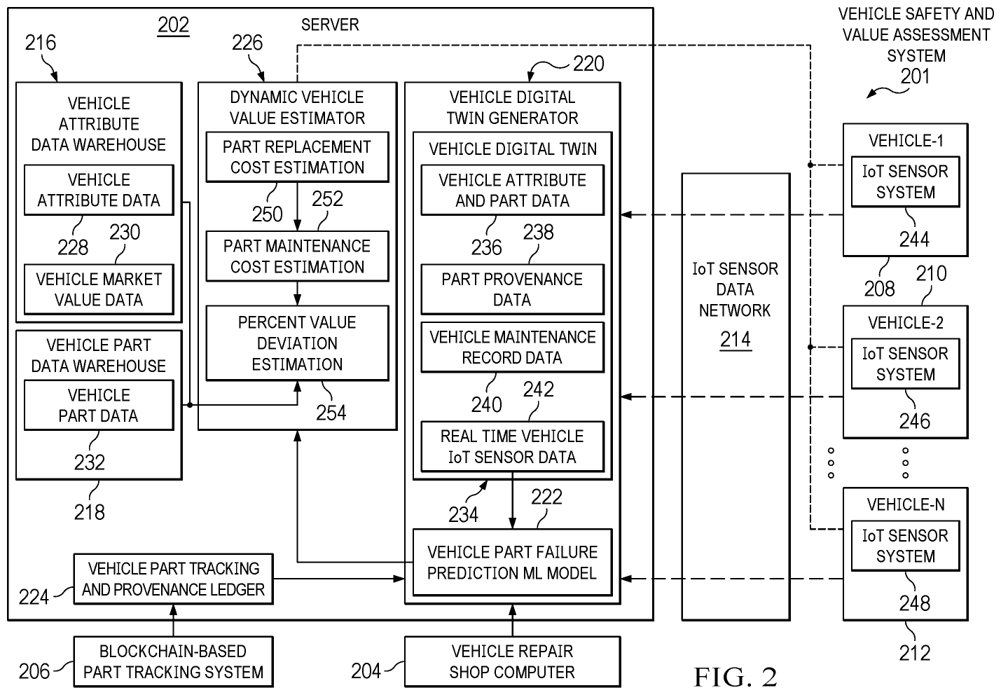

With reference now to FIG. 2, a diagram illustrating an example of a vehicle safety and value assessment system is depicted in accordance with an illustrative embodiment. Vehicle safety and value assessment system 201 may be implemented in a computing environment, such as computing environment 100 in FIG. 1. Vehicle safety and value assessment system 201 is a system of hardware and software components for assessing vehicle safety and value based on predicted vehicle part failure within a defined time period.

In this example, vehicle safety and value assessment system 201 includes server 202, vehicle repair shop computer 204, blockchain-based part tracking system 206, vehicle-1 208, vehicle-2 210, vehicle-N 212, and IoT sensor data network 214. However, vehicle safety and value assessment system 201 is intended as an example only and not as a limitation on illustrative embodiments. For example, vehicle safety and value assessment system 201 can include any number of servers, vehicle repair shop computers, part tracking systems, vehicles, and networks, as well as other devices and components not shown.

Server 202 may be, for example, computer 101 in FIG. 1. In this example, server 202 includes vehicle attribute data warehouse 216, vehicle part data warehouse 218, vehicle digital twin generator 220, vehicle part failure prediction machine learning model 222, vehicle part tracking and provenance ledger 224, and dynamic vehicle value estimator 226. Vehicle attribute data warehouse 216 contains vehicle attribute data 228 and vehicle market value data 230. Vehicle attribute data 228 include vehicle attributes, such as, for example, vehicle year, vehicle make, vehicle model, vehicle mileage, and the like corresponding to a plurality of different vehicles. Vehicle market value data 230 include, for example, current estimated market values corresponding to each of the plurality of different vehicles. Vehicle part data warehouse 218 contains vehicle part data 232. Vehicle part data 232 include, for example, descriptions and stock keeping units for parts corresponding to each of the plurality of different vehicles according to vehicle year, make, and model, along with cost of the parts, average longevity of the parts, manufacturer of the parts, cost to repair the parts, and the like.

Vehicle digital twin generator 220 generates vehicle digital twin 234 for each of vehicle-1 208, vehicle-2 210, and vehicle-N 212 based on vehicle attribute and part data 236, part provenance data 238, vehicle maintenance record data 240, and real time vehicle IoT sensor data 242. Vehicle digital twin generator 220 obtains vehicle attribute and part data 236 for each of vehicle-1 208, vehicle-2 210, and vehicle-N 212 from vehicle attribute data 228 in vehicle attribute data warehouse 216 and vehicle parts data 232 in vehicle parts data warehouse 218. Vehicle digital twin generator 220 obtains part provenance data 238 for each of vehicle-1 208, vehicle-2 210, and vehicle-N 212 from vehicle part tracking and provenance ledger 224. Server 202 generates vehicle part tracking and provenance ledger 224 based on information retrieved from blockchain-based part tracking system 206. Part provenance data 238 provide source and authenticity information regarding each currently installed part on vehicle-1 208, vehicle-2 210, and vehicle-N 212. Vehicle digital twin generator 220 obtains vehicle maintenance record data 240 for each of vehicle-1 208, vehicle-2 210, and vehicle-N 212 from vehicle repair shop computer 204, which can represent a plurality of different vehicle repair shop computers. Vehicle digital twin generator 220 obtains real time vehicle IoT sensor data 242 for each of vehicle-1 208, vehicle-2 210, and vehicle-N 212 from IoT sensor system 244, IoT sensor system 246, and IoT sensor system 248, respectively, via IoT sensor data network 214. IoT sensor data network 214 may be, for example, WAN 102 in FIG. 1. Real time vehicle IoT sensor data 242 provide operational and performance information regarding the different parts comprising each of vehicle-1 208, vehicle-2 210, and vehicle-N 212.

Vehicle digital twin generator 220 utilizes vehicle part failure prediction machine learning model 222 to analyze all of the data (i.e., vehicle attribute and part data 236, part provenance data 238, vehicle maintenance record data 240, and real time vehicle IoT sensor data 242) contained in vehicle digital twin 234 of vehicle-1 208, vehicle-2 210, and vehicle-N 212. Based on the analysis of the data contained in vehicle digital twin 234 of vehicle-1 208, vehicle-2 210, and vehicle-N 212, vehicle part failure prediction machine learning model 222 predicts whether a set of one or more parts is likely to fail on vehicle-1 208, vehicle-2 210, or vehicle-N 212 within a defined time period. The defined time period may be, for example, one week, two weeks, one month, two months, three months, six months, or any other defined period of time.

Based on determining that a set of parts is likely to fail on at least one of vehicle digital twin 234 of vehicle-1 208, vehicle-2 210, or vehicle-N 212, vehicle part failure prediction machine learning model 222 identifies the set of parts likely to fail within the defined time period for dynamic vehicle value estimator 226. Then, dynamic vehicle value estimator 226 generates part replacement cost estimation 250 for each of the set of parts likely to fail and part maintenance cost estimation 252 for each replacement part corresponding to each of the set of parts likely to fail. Afterward, dynamic vehicle value estimator 226 generates percent value deviation estimation 254 from a baseline value corresponding to the vehicle (e.g., vehicle-1 208) containing the set of parts likely to fail based on part replacement cost estimation 250 and part maintenance cost estimation 252. Based on percent value deviation estimation 254 from the baseline value corresponding to the vehicle containing the set of parts likely to fail, dynamic vehicle value estimator generates a real time actual value for the vehicle.

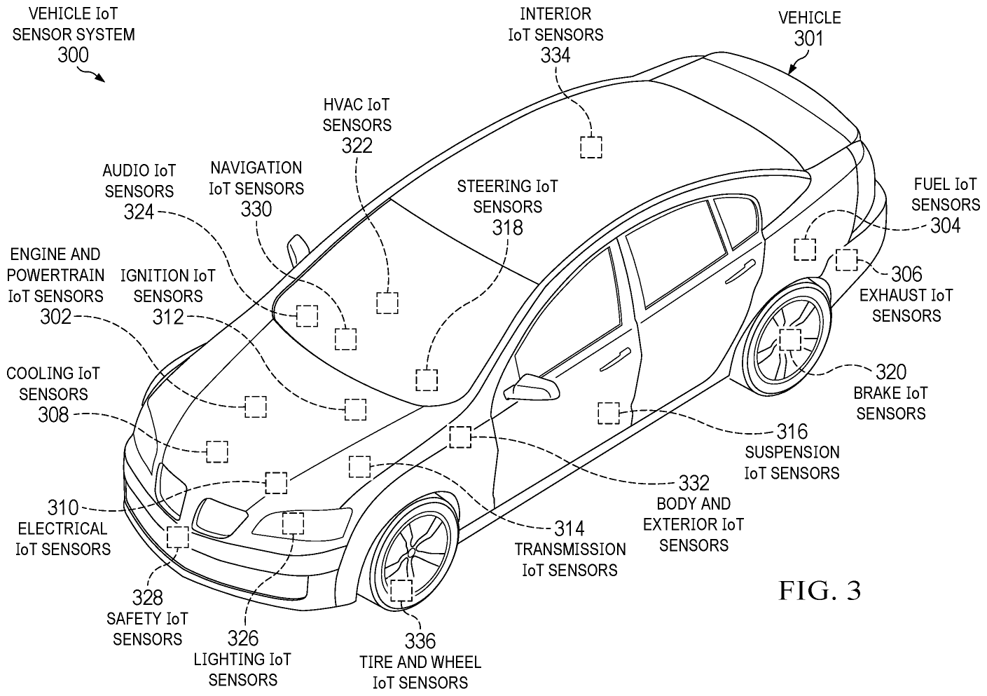

With reference now to FIG. 3, a diagram illustrating an example of a vehicle IoT sensor system is depicted in accordance with an illustrative embodiment. Vehicle IoT sensor system 300 is implemented in vehicle 301. Vehicle 301 may be, for example, vehicle 103 in FIG. 1 or vehicle-1 208 in FIG. 2. Vehicle IoT sensor system 300 may be, for example, IoT sensor system 107 in FIG. 1 or IoT sensor system 244 in FIG. 2.

Vehicle IoT sensor system 300 includes a plurality of different sets of IoT sensors corresponding to different parts, components, or subsystems of vehicle 301. For example, vehicle IoT sensor system 300 includes engine and powertrain IoT sensors 302, fuel IoT sensors 304, exhaust IoT sensors 306, cooling IoT sensors 308, electrical IoT sensors 310, ignition IoT sensors 312, transmission IoT sensors 314, suspension IoT sensors 316, steering IoT sensors 318, brake IoT sensors 320, Heating, Ventilation, and Air Conditioning (HVAC) IoT sensors 322, audio IoT sensors 324, lighting IoT sensors 326, safety IoT sensors 328, navigation IoT sensors 330, body and exterior IoT sensors 332, interior IoT sensors 334, and tire and wheel IoT sensors 336.

Engine and powertrain IoT sensors 302 include, for example, temperature sensors, pressure sensors, vibration sensors, fluid level sensors, and the like. Fuel IoT sensors 304 include, for example, fuel level sensors, fuel flow sensors, fuel pressure sensors, and the like. Exhaust IoT sensors 306 include, for example, emission sensors, temperature sensors, and the like. Cooling IoT sensors 308 include, for example, temperature sensors, pressure sensors, coolant level sensors, and the like. Electrical IoT sensors 310 include, for example, voltage sensors, current sensors, battery charge sensors, and the like. Ignition IoT sensors 312 include, for example, spark plug sensors, ignition timing sensors, and the like. Transmission IoT sensors 314 include, for example, transmission fluid temperature sensors, gear position sensors, transmission speed sensors, and the like. Suspension IoT sensors 316 include, for example, shock absorber sensors, ride height sensors, wheel alignment sensors, and the like. Steering IoT sensors 318 include, for example, steering angle sensors, steering wheel position sensors, and the like. Brake IoT sensors 320 include, for example, brake pad wear sensors, brake fluid level sensors, brake temperature sensors, and the like. HVAC IoT sensors 322 include, for example, temperature sensors, humidity sensors, air quality sensors, and the like. Audio IoT sensors 324 include, for example, microphone sensors, speaker sensors, and the like. Lighting IoT sensors 326 include, for example, light intensity sensors, ambient light sensors, and the like. Safety IoT sensors 328 include, for example, accelerometer sensors, pressure sensors, collision sensors, lane departure sensors, motion sensors, and the like. Navigation IoT sensors 330 include, for example, GPS sensors, inertial sensors, and the like. Body and exterior IoT sensors 332 include, for example, proximity sensors, imaging sensors, ultrasonic sensors, and the like. Interior IoT sensors 334 include, for example, occupant sensors, seatbelt sensors, temperature sensors, motion sensors, sound sensors, imaging sensors, and the like. Tire and wheel IoT sensors 336 include, for example, tire pressure sensors, tire temperature sensors, wheel speed sensors, and the like.

However, it should be noted that vehicle IoT sensor system 300 is intended as an example only and not as a limitation on illustrative embodiments. In other words, vehicle IoT sensor system 300 can includes any number and type of IoT sensors. For example, two or more IoT sensors can be combined, one IoT sensor can be divided into two or more IoT sensors, one or more IoT sensors shown can be removed, or one or more IoT sensors not shown can be added.

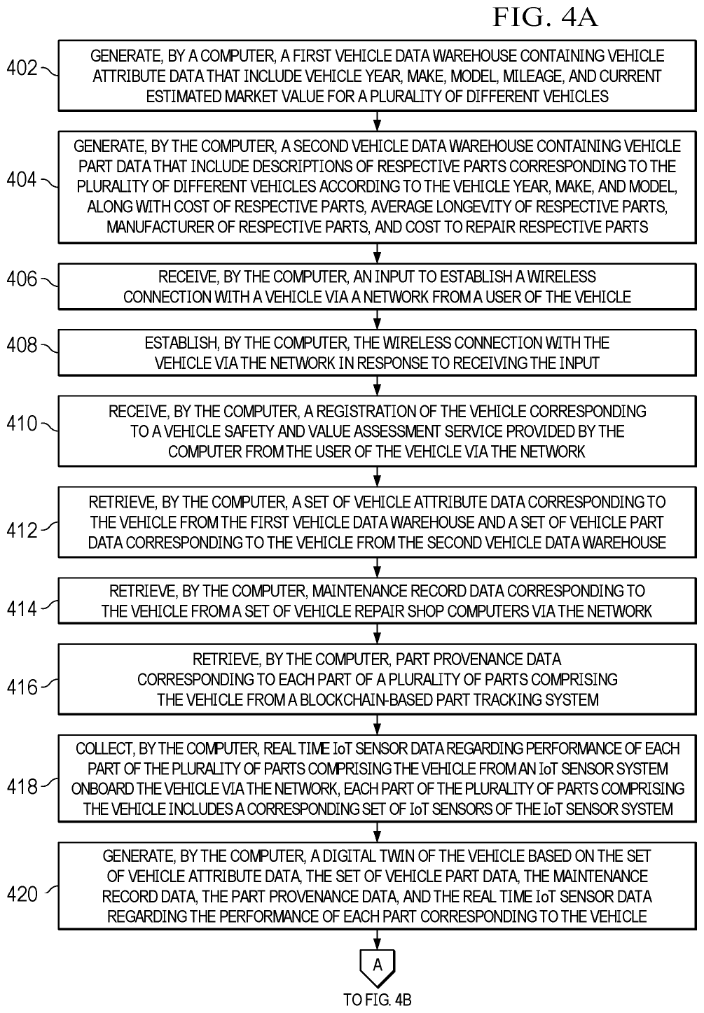

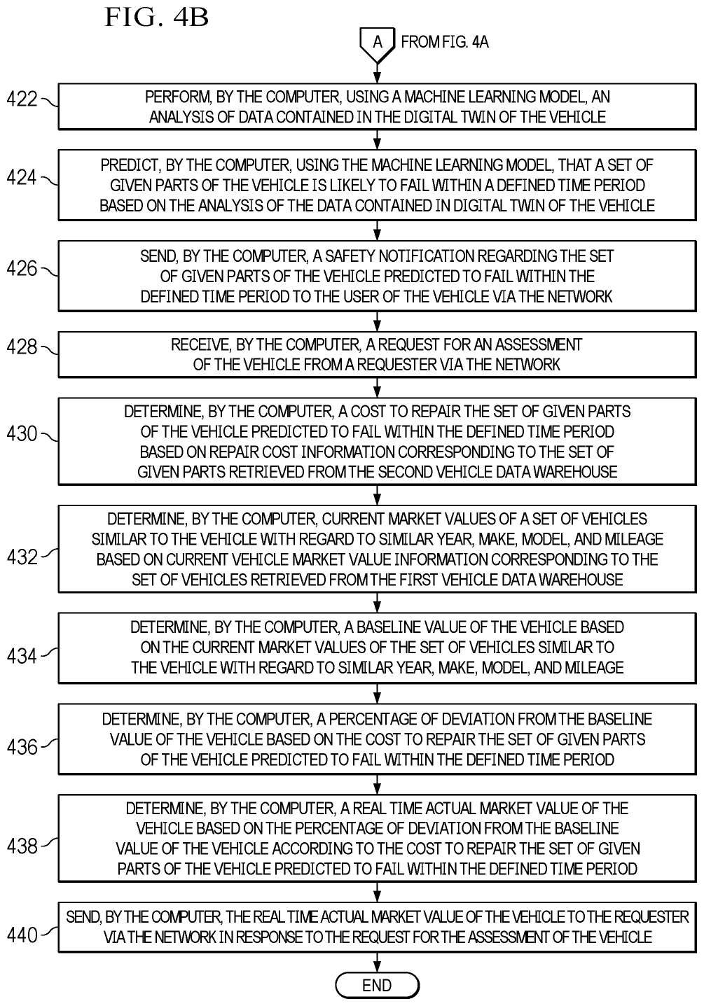

With reference now to FIGS. 4A-4B, a flowchart illustrating a process for dynamic vehicle safety and value assessment is shown in accordance with an illustrative embodiment. The process shown in FIGS. 4A-4B may be implemented in a computer, such as, for example, computer 101 in FIG. 1 or server 202 in FIG. 2. For example, the process shown in FIGS. 4A-4B may be implemented in vehicle safety and value assessment code 200 in FIG. 1.

The process begins when the computer generates a first vehicle data warehouse containing vehicle attribute data that include vehicle year, make, model, mileage, and current estimated market value for a plurality of different vehicles (step 402). In addition, the computer generates a second vehicle data warehouse containing vehicle part data that include descriptions of respective parts corresponding to the plurality of different vehicles according to the vehicle year, make, and model, along with cost of respective parts, average longevity of respective parts, manufacturer of respective parts, and cost to repair respective parts (step 404).

Subsequently, the computer receives an input to establish a wireless connection with a vehicle via a network from a user of the vehicle (step 406). The user may be, for example, the owner of the vehicle. The computer establishes the wireless connection with the vehicle via the network in response to receiving the input (step 408). The computer receives a registration of the vehicle corresponding to a vehicle safety and value assessment service provided by the computer from the user of the vehicle via the network (step 410).

In response to receiving the registration of the vehicle, the computer retrieves a set of vehicle attribute data corresponding to the vehicle from the first vehicle data warehouse and a set of vehicle part data corresponding to the vehicle from the second vehicle data warehouse (step 412). Further, the computer retrieves maintenance record data corresponding to the vehicle from a set of vehicle repair shop computers via the network (step 414). Furthermore, the computer retrieves part provenance data corresponding to each part of a plurality of parts comprising the vehicle from a blockchain-based part tracking system (step 416). Moreover, the computer collects real time IoT sensor data regarding performance of each part of the plurality of parts comprising the vehicle from an IoT sensor system onboard the vehicle via the network (step 418). Each part of the plurality of parts comprising the vehicle includes a corresponding set of IoT sensors of the IoT sensor system.

The computer generates a digital twin of the vehicle based on the set of vehicle attribute data, the set of vehicle part data, the maintenance record data, the part provenance data, and the real time IoT sensor data regarding the performance of each part corresponding to the vehicle (step 420). The computer, using a machine learning model, performs an analysis of data contained in the digital twin of the vehicle (step 422). The computer, using the machine learning model, predicts that a set of given parts of the vehicle is likely to fail within a defined time period based on the analysis of the data contained in digital twin of the vehicle (step 424). The computer sends a safety notification regarding the set of given parts of the vehicle predicted to fail within the defined time period to the user of the vehicle via the network (step 426).

The computer receives a request for an assessment of the vehicle from a requester via the network (step 428). The requestor may be a potential buyer of the vehicle or the user of the vehicle. The computer determines a cost to repair the set of given parts of the vehicle predicted to fail within the defined time period based on repair cost information corresponding to the set of given parts retrieved from the second vehicle data warehouse (step 430).

In addition, the computer determines current market values of a set of vehicles similar to the vehicle with regard to similar year, make, model, and mileage based on current vehicle market value information corresponding to the set of vehicles retrieved from the first vehicle data warehouse (step 432). The computer also determines a baseline value of the vehicle based on the current market values of the set of vehicles similar to the vehicle with regard to similar year, make, model, and mileage (step 434).

Afterward, the computer determines a percentage of deviation from the baseline value of the vehicle based on the cost to repair the set of given parts of the vehicle predicted to fail within the defined time period (step 436). The computer determines a real time actual market value of the vehicle based on the percentage of deviation from the baseline value of the vehicle according to the cost to repair the set of given parts of the vehicle predicted to fail within the defined time period (step 438). The computer sends the real time actual market value of the vehicle to the requester via the network in response to the request for the assessment of the vehicle (step 440). Thereafter, the process terminates.

Thus, illustrative embodiments of the present disclosure provide a computer-implemented method, computer system, and computer program product for dynamic vehicle value assessment enabled by real time network IoT sensor data analysis. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for dynamic vehicle assessment, the computer-implemented method comprising:
determining, by a computer, a baseline value of a vehicle based on current market values of a set of vehicles similar to the vehicle with regard to similar year, make, model, and mileage;
determining, by the computer, a percentage of deviation from the baseline value of the vehicle based on a cost to repair a set of given parts of the vehicle predicted to fail within a defined time period;
determining, by the computer, a real time actual market value of the vehicle based on the percentage of deviation from the baseline value of the vehicle according to the cost to repair the set of given parts of the vehicle predicted to fail within the defined time period; and
sending, by the computer, the real time actual market value of the vehicle to a requester via a network in response to receiving a request for an assessment of the vehicle.

2. The computer-implemented method of claim 1, further comprising:
receiving, by the computer, the request for the assessment of the vehicle from the requester via the network;
determining, by the computer, the cost to repair the set of given parts of the vehicle predicted to fail within the defined time period based on repair cost information corresponding to the set of given parts retrieved from a second vehicle data warehouse; and
determining, by the computer, the current market values of the set of vehicles similar to the vehicle with regard to similar year, make, model, and mileage based on current vehicle market value information corresponding to the set of vehicles retrieved from a first vehicle data warehouse.

3. The computer-implemented method of claim 1, further comprising:
performing, by the computer, using a machine learning model, an analysis of data contained in a digital twin of the vehicle;
predicting, by the computer, using the machine learning model, that the set of given parts of the vehicle is likely to fail within the defined time period based on the analysis of the data contained in digital twin of the vehicle; and
sending, by the computer, a safety notification regarding the set of given parts of the vehicle predicted to fail within the defined time period to a user of the vehicle via the network.

4. The computer-implemented method of claim 1, further comprising:
collecting, by the computer, real time Internet of Things (IoT) sensor data regarding performance of each part of a plurality of parts comprising the vehicle from an IoT sensor system onboard the vehicle via the network, each part of the plurality of parts comprising the vehicle includes a corresponding set of IoT sensors of the IoT sensor system; and
generating, by the computer, a digital twin of the vehicle based on a set of vehicle attribute data, a set of vehicle part data, maintenance record data, part provenance data, and the real time IoT sensor data regarding the performance of each part corresponding to the vehicle.

5. The computer-implemented method of claim 4, further comprising:
retrieving, by the computer, the set of vehicle attribute data corresponding to the vehicle from a first vehicle data warehouse and the set of vehicle part data corresponding to the vehicle from a second vehicle data warehouse;
retrieving, by the computer, the maintenance record data corresponding to the vehicle from a set of vehicle repair shop computers via the network; and
retrieving, by the computer, the part provenance data corresponding to each part of a plurality of parts comprising the vehicle from a blockchain-based part tracking system.

6. The computer-implemented method of claim 5, further comprising:
generating, by the computer, the first vehicle data warehouse containing vehicle attribute data that include vehicle year, make, model, mileage, and current estimated market value for a plurality of different vehicles; and
generating, by the computer, the second vehicle data warehouse containing vehicle part data that include descriptions of respective parts corresponding to the plurality of different vehicles according to the vehicle year, make, and model, along with cost of respective parts, average longevity of respective parts, manufacturer of respective parts, and cost to repair respective parts.

7. The computer-implemented method of claim 1, further comprising:
receiving, by the computer, an input to establish a wireless connection with the vehicle via the network from a user of the vehicle;
establishing, by the computer, the wireless connection with the vehicle via the network in response to receiving the input; and
receiving, by the computer, a registration of the vehicle corresponding to a vehicle safety and value assessment service provided by the computer from the user of the vehicle via the network.

8. A computer system for dynamic vehicle assessment, the computer system comprising:
a communication fabric;
a storage device connected to the communication fabric, wherein the storage device stores program instructions; and
a processor connected to the communication fabric, wherein the processor executes the program instructions to:
determine a baseline value of a vehicle based on current market values of a set of vehicles similar to the vehicle with regard to similar year, make, model, and mileage;
determine a percentage of deviation from the baseline value of the vehicle based on a cost to repair a set of given parts of the vehicle predicted to fail within a defined time period;
determine a real time actual market value of the vehicle based on the percentage of deviation from the baseline value of the vehicle according to the cost to repair the set of given parts of the vehicle predicted to fail within the defined time period; and
send the real time actual market value of the vehicle to a requester via a network in response to receiving a request for an assessment of the vehicle.

9. The computer system of claim 8, wherein the processor further executes the program instructions to:
receive the request for the assessment of the vehicle from the requester via the network;
determine the cost to repair the set of given parts of the vehicle predicted to fail within the defined time period based on repair cost information corresponding to the set of given parts retrieved from a second vehicle data warehouse; and
determine the current market values of the set of vehicles similar to the vehicle with regard to similar year, make, model, and mileage based on current vehicle market value information corresponding to the set of vehicles retrieved from a first vehicle data warehouse.

10. The computer system of claim 8, wherein the processor further executes the program instructions to:
perform, using a machine learning model, an analysis of data contained in a digital twin of the vehicle;
predict, using the machine learning model, that the set of given parts of the vehicle is likely to fail within the defined time period based on the analysis of the data contained in digital twin of the vehicle; and
send a safety notification regarding the set of given parts of the vehicle predicted to fail within the defined time period to a user of the vehicle via the network.

11. The computer system of claim 8, wherein the processor further executes the program instructions to:
collect real time Internet of Things (IoT) sensor data regarding performance of each part of a plurality of parts comprising the vehicle from an IoT sensor system onboard the vehicle via the network, each part of the plurality of parts comprising the vehicle includes a corresponding set of IoT sensors of the IoT sensor system; and
generate a digital twin of the vehicle based on a set of vehicle attribute data, a set of vehicle part data, maintenance record data, part provenance data, and the real time IoT sensor data regarding the performance of each part corresponding to the vehicle.

12. The computer system of claim 11, wherein the processor further executes the program instructions to:
retrieve the set of vehicle attribute data corresponding to the vehicle from a first vehicle data warehouse and the set of vehicle part data corresponding to the vehicle from a second vehicle data warehouse;
retrieve the maintenance record data corresponding to the vehicle from a set of vehicle repair shop computers via the network; and
retrieve the part provenance data corresponding to each part of a plurality of parts comprising the vehicle from a blockchain-based part tracking system.

13. The computer system of claim 12, wherein the processor further executes the program instructions to:
generate the first vehicle data warehouse containing vehicle attribute data that include vehicle year, make, model, mileage, and current estimated market value for a plurality of different vehicles; and
generate the second vehicle data warehouse containing vehicle part data that include descriptions of respective parts corresponding to the plurality of different vehicles according to the vehicle year, make, and model, along with cost of respective parts, average longevity of respective parts, manufacturer of respective parts, and cost to repair respective parts.

14. A computer program product for dynamic vehicle assessment, the computer program product comprising a computer-readable storage medium having program instructions embodied therewith, the program instructions executable by a computer to cause the computer to:
determine a baseline value of a vehicle based on current market values of a set of vehicles similar to the vehicle with regard to similar year, make, model, and mileage;
determine a percentage of deviation from the baseline value of the vehicle based on a cost to repair a set of given parts of the vehicle predicted to fail within a defined time period;
determine a real time actual market value of the vehicle based on the percentage of deviation from the baseline value of the vehicle according to the cost to repair the set of given parts of the vehicle predicted to fail within the defined time period; and
send the real time actual market value of the vehicle to a requester via a network in response to receiving a request for an assessment of the vehicle.

15. The computer program product of claim 14, wherein the program instructions further cause the computer to:
receive the request for the assessment of the vehicle from the requester via the network;
determine the cost to repair the set of given parts of the vehicle predicted to fail within the defined time period based on repair cost information corresponding to the set of given parts retrieved from a second vehicle data warehouse; and
determine the current market values of the set of vehicles similar to the vehicle with regard to similar year, make, model, and mileage based on current vehicle market value information corresponding to the set of vehicles retrieved from a first vehicle data warehouse.

16. The computer program product of claim 14, wherein the program instructions further cause the computer to:
perform, using a machine learning model, an analysis of data contained in a digital twin of the vehicle;
predict, using the machine learning model, that the set of given parts of the vehicle is likely to fail within the defined time period based on the analysis of the data contained in digital twin of the vehicle; and
send a safety notification regarding the set of given parts of the vehicle predicted to fail within the defined time period to a user of the vehicle via the network.

17. The computer program product of claim 14, wherein the program instructions further cause the computer to:
collect real time Internet of Things (IoT) sensor data regarding performance of each part of a plurality of parts comprising the vehicle from an IoT sensor system onboard the vehicle via the network, each part of the plurality of parts comprising the vehicle includes a corresponding set of IoT sensors of the IoT sensor system; and
generate a digital twin of the vehicle based on a set of vehicle attribute data, a set of vehicle part data, maintenance record data, part provenance data, and the real time IoT sensor data regarding the performance of each part corresponding to the vehicle.

18. The computer program product of claim 17, wherein the program instructions further cause the computer to:
retrieve the set of vehicle attribute data corresponding to the vehicle from a first vehicle data warehouse and the set of vehicle part data corresponding to the vehicle from a second vehicle data warehouse;
retrieve the maintenance record data corresponding to the vehicle from a set of vehicle repair shop computers via the network; and
retrieve the part provenance data corresponding to each part of a plurality of parts comprising the vehicle from a blockchain-based part tracking system.

19. The computer program product of claim 18, wherein the program instructions further cause the computer to:
generate the first vehicle data warehouse containing vehicle attribute data that include vehicle year, make, model, mileage, and current estimated market value for a plurality of different vehicles; and
generate the second vehicle data warehouse containing vehicle part data that include descriptions of respective parts corresponding to the plurality of different vehicles according to the vehicle year, make, and model, along with cost of respective parts, average longevity of respective parts, manufacturer of respective parts, and cost to repair respective parts.

20. The computer program product of claim 14, wherein the program instructions further cause the computer to:
receive an input to establish a wireless connection with the vehicle via the network from a user of the vehicle;
establish the wireless connection with the vehicle via the network in response to receiving the input; and
receive a registration of the vehicle corresponding to a vehicle safety and value assessment service provided by the computer from the user of the vehicle via the network.
